(19) United States
(12) Patent Application Publication
(10) Pub. No.: US 2014/0055312 A1
(43) Pub. Date: Feb. 27, 2014

(54) SYSTEMS AND METHODS FOR A DUAL POLARIZATION FEED

(71) Applicant: Michael G. Guler, Dawsonville, GA (US)

(72) Inventor: Michael G. Guler, Dawsonville, GA (US)

(73) Assignee: HONEYWELL INTERNATIONAL INC., Morristown, NJ (US)

(21) Appl. No.: 13/595,216

(22) Filed: Aug. 27, 2012

(51) Int. Cl. H01Q 13/00; H01Q 13/02

(52) U.S. Cl. 343/785; 343/772; 343/786

(57) ABSTRACT

Systems and methods for a dual polarization feed are provided. In at least one embodiment, a system comprises a polarization transition waveguide that comprises a first waveguide transmission line; an electrical transmission line, wherein a first electromagnetic signal propagating through the first waveguide transmission line propagates between the first waveguide transmission line and the electrical transmission line; and a dipole radiator coupled to the electrical transmission line, wherein the dipole radiator radiates the first electromagnetic signal in an orthogonal polarization to the polarization of the first electromagnetic signal when the first electromagnetic signal propagates in the first waveguide transmission line. The system further comprises a second waveguide transmission line that propagates a second electromagnetic signal having the same polarization as a signal propagating in the first waveguide transmission line; and a waveguide element coupled to both the polarization transition waveguide and the second waveguide transmission line.

### BACKGROUND

Antennas can be used to emit signals having different polarizations. In certain examples, these antennas are part of antenna array elements. Depending on the frequency of the signals emitted from antennas in an array, the antenna arrays can be designed so that the different antenna elements in the antenna array are placed in a compact arrangement to prevent the creation of grating lobes. In some embodiments, to fabricate an antenna array with a sufficiently compact arrangement, the antennas are fabricated with stripline circuitry. However, stripline circuitry can be too lossy at millimeter wave frequencies for certain applications.

In contrast to stripline circuitry, waveguide feeds can provide dual polarization at millimeter wave frequencies. However, waveguide feeds that are arranged for emitting dual polarized signals consume enough area to inhibit grating lobe free spacing of the array elements. Further, waveguides in dual-polarized waveguide feeds emit signals of different polarizations from different locations. Because the waveguide feeds emit signals at different locations, the dual polarized signals become distorted when the signal is received by a receiver that is not equidistant from the sources of the emitted dual polarized signals.

### SUMMARY

Systems and methods for a dual polarization feed are provided. In at least one embodiment, a system comprises a polarization transition waveguide that comprises a first waveguide transmission line; an electrical transmission line coupled to the first waveguide transmission line, wherein a first electromagnetic signal propagating through the first waveguide transmission line propagates between the first waveguide transmission line and the electrical transmission line; and a dipole radiator coupled to the electrical transmission line, wherein the first electromagnetic signal propagates between the electrical transmission line and the dipole radiator, wherein the dipole radiator radiates the first electromagnetic signal in a polarization that is orthogonal to the polarization of the first electromagnetic signal when the first electromagnetic signal propagates in the first waveguide transmission line. The system further comprises a second waveguide transmission line that propagates a second electromagnetic signal having the same polarization as the first electromagnetic signal propagating in the first waveguide transmission line; and a waveguide element coupled to both the polarization transition waveguide and the second waveguide transmission line, wherein the waveguide element propagates both the first electromagnetic signal emitted from the dipole radiator and the second electromagnetic signal.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1A is a block diagram of a dual polarization feed for a waveguide element in one embodiment described by the present disclosure;

FIG. 1B is a perspective view of one embodiment of the dual polarization feed for a waveguide element described in relation to FIG. 1A;

FIG. 2 is a side perspective view of a waveguide to dipole transition in one embodiment described by the present disclosure;

FIG. 3 is a side view of a waveguide septum in one embodiment described by the present disclosure;

FIGS. 4A and 4B are perspective views of a dual polarization feed for different types of waveguide elements according to embodiments described by the present disclosure; and

FIGS. 5A and 5B are top views of antenna arrays that implement a dual polarization feed according to embodiments described by the present disclosure; and

FIG. 6 is a flow diagram of a method for emitting dual polarized signals through a waveguide element in one embodiment described by the present disclosure.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

In certain embodiments, a compact arrangement of waveguides can be used to provide dual polarized signals. The compact arrangement can provide dual polarized signals within an antenna array where the different elements in the antenna array are spaced sufficiently close to one another to inhibit the formation of grating lobes. The compact arrangement includes two, parallel, rectangular waveguides that both propagate electromagnetic energy in the same polarization. Further, one of the rectangular waveguides is coupled to a waveguide to dipole transition. The waveguide to dipole transition rotates the polarization of electromagnetic energy propagating through the waveguide such that a dipole in the waveguide to dipole transition emits a signal that is polarized with a polarization that is orthogonal to the polarization of the signal that is propagating through the waveguides.

In a further embodiment, both of the parallel rectangular waveguides are coupled to a waveguide element that radiates the dual polarized electromagnetic energy. Further, the waveguide element co-locates both of the dual polarization signals such that both of the dual polarization signals are emitted from the same location. The compact arrangement of the parallel waveguides and the co-location of dual polarized signals allow for more closely spaced transmission antennas and also allow a receiver to be placed at different locations without distorting the polarization of the emitted signals in relation to one another.

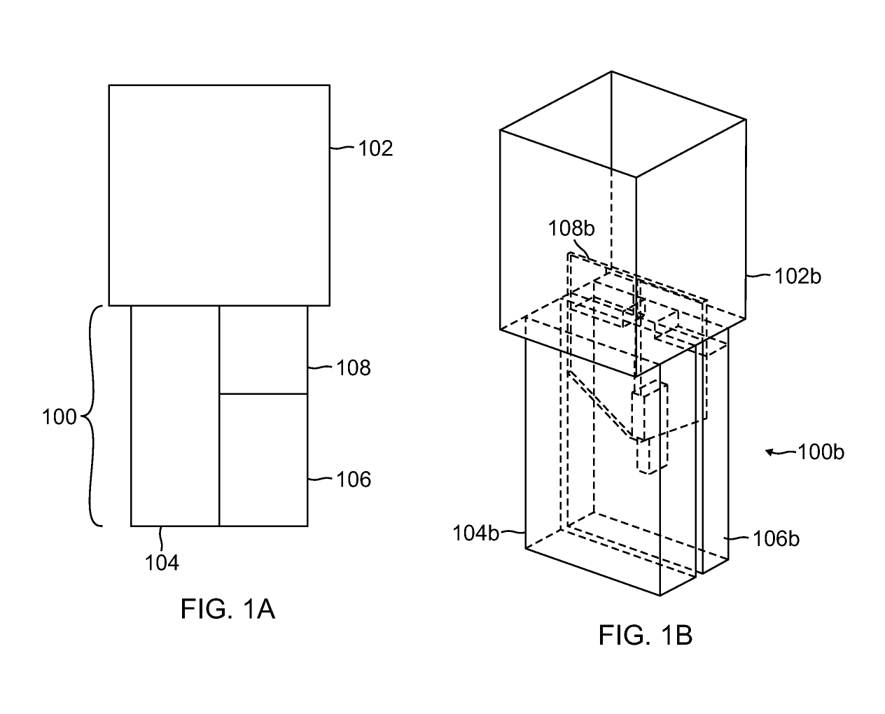

FIG. 1A is a block diagram of a dual polarization feed 100 for a waveguide element 102. Dual polarization feed 100 provides two orthogonally polarized signals to a waveguide element 102. When waveguide element 102 receives two orthogonally polarized signals from dual polarization feed 100, the two orthogonally polarized signals become co-located within waveguide element 102. To perform the co-location, as shown in FIG. 1A, waveguide element 102 can be a rectangular waveguide. However, waveguide element 102 can be other shapes as illustrated below such as a horn, a circular waveguide, and the like. Because the two orthogonally polarized signals are co-located within waveguide element 102, when the signals are emitted from waveguide element 102, the dually polarized signals are emitted at the same location. Because the dual orthogonally polarized signals are co-located within a single waveguide element 102, the dual orthogonally polarized signals propagate within and are emitted from a single waveguide element 102. Due to the emission of the signals from a single waveguide element 102, the dually polarized signals can be received by a receiver without distortion that results when a receiver is located at different distances from the emission sources of different polarized signals. Multiple dual polarization feeds 100 and waveguide elements 102 can be placed in a sufficiently compact arrangement to suppress grating lobes that can occur when antennas in an array are spaced far apart.

To provide orthogonally polarized signals, dual polarization feed 100 includes a first waveguide 104 and a second waveguide 106. Both the first waveguide 104 and the second waveguide 106 propagate signals towards waveguide element 102 in a first polarization. The first waveguide 104 and the second waveguide 106 can be a standard TE₁₀ mode waveguides, however, the first waveguide 104 and the second waveguide 106 can propagate other modes as well. The first waveguide 104 is coupled directly to the waveguide element 102 and emits a first signal having a first polarization into the waveguide element 102. In contrast to the first waveguide 104, the second waveguide 106 functions as a polarization transition waveguide. Where a polarization transition waveguide rotates the polarity of a signal so that the polarity of the signal is orthogonal to the propagation modes of the waveguide. To function as a polarization transition waveguide, the second waveguide 106 is coupled to the waveguide element 102 via a waveguide to dipole transition 108 that rotates the polarization of a second signal propagating through the second waveguide 106 such that the polarization of the second signal that is emitted into the waveguide element 102 is orthogonal to the polarization of the first signal propagating within waveguide element 102. Also, the polarization of the second signal as it propagates within the waveguide element 102 is orthogonal to the polarization of the second signal as it propagates through the second waveguide 106.

In the illustrated embodiment, the first waveguide 104 and the second waveguide 106 can radiate electromagnetic energy having polarizations that are orthogonal to one another. Because the first waveguide 104 and the second waveguide 106 propagate signals of the same frequency, mode, and polarization; when the first waveguide 104 and the second waveguide 106 are rectangular waveguides, the first waveguide 104 and the second waveguide 106 can be placed next to each other in a parallel arrangement. The parallel arrangement of the first waveguide 104 and the second waveguide 106 allow the respective waveguide structures to be spaced closer together when providing dually polarized signals to the waveguide element 102. The close proximity of the first waveguide 104 to the second waveguide 106 aides in the suppression of grating lobes that can occur when the waveguide element 102 and the dual polarization feed 100 are part of an antenna array containing multiple closely spaced waveguide elements 102 and dual polarization feeds 100.

As described above, the second waveguide 106 can rotate the polarization of a signal propagating through the second waveguide 106 by implementing a waveguide to dipole transition 108. Waveguide to dipole transition 108 is described in detail in co-pending U.S. patent application Ser. No. 12/882,897 (published as publication number 2011/0063053) entitled “WAVEGUIDE TO DIPOLE TRANSISTION” filed on Sep. 15, 2010, herein incorporated in its entirety by reference and referred to herein as the '897 application.

FIG. 1B is a side perspective view of one embodiment of the dual polarization feed of FIG. 1A. In certain embodiments, dual polarization feed 100b can function as dual polarization feed 100 in FIG. 1A. Dual polarization feed 100b includes a first waveguide 104b and a second waveguide 106b. The second waveguide 106b is coupled to a waveguide to dipole transition 108b, where the waveguide to dipole transition 108b rotates the polarization of an electromagnetic signal by transitioning the signal from the waveguide 106b into an electrical transmission line and propagating the signal towards a dipole radiator. Although the electrical transmission line in FIG. 1B is microstripline, other transmission line types such as stripline could be used. The dipole radiator emits radiation into waveguide element 102b at a polarization that is orthogonal to the polarization of signals propagating within the first waveguide 104b and the second waveguide 106b. The waveguide element 102b propagates both signals having orthogonal polarizations.

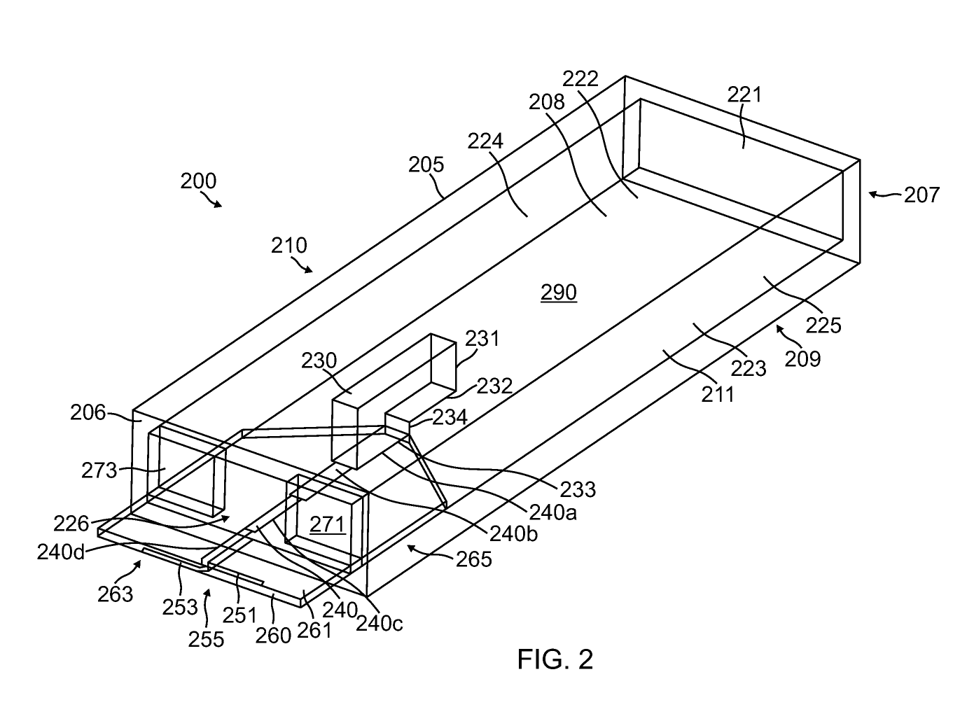

FIG. 2 provides a side perspective view of an exemplary polarization transition waveguide 200 having an accompanying waveguide to dipole transition in accordance with certain exemplary embodiments. In some implementations, polarization transition waveguide 200 functions as the second waveguide 106 described in FIG. 1.

The polarization transition waveguide 200 includes a waveguide transmission line (“waveguide”) 205 having an aperture or opening 226 in a proximate end 206 that is located at the opening of the waveguide 205 that is proximate a waveguide to dipole transition and also proximate to waveguide element 102 described in FIG. 1. Further waveguide 205 includes a distal end 207 opposite the proximate end 206. The distal end 207 can include an opening 221 for receiving or transmitting electromagnetic energy, for example in the form of a TE₁₀ mode electromagnetic field.

As described below, to aid in the description of further components of waveguide 205, the orientation of some of the components will be described in reference to the H-plane and the E-plane of the waveguide 205. The H-plane, as used herein, refers to a plane that is parallel to the magnetic field vector of the dominant electromagnetic wave that propagates within the waveguide 205. Conversely, the E-plane, as used herein, refers to a plane that is parallel to the electric field vector of the dominant electromagnetic wave that propagates within the waveguide 205 and is also orthogonal to the H-plane.

In certain embodiments, the exemplary waveguide 205 includes external walls 208, 209, 210, and 211; and internal walls 222, 223, 224, and 225, where the external walls are in contact with the external environment containing the waveguide 205 and the internal walls enclose and are in contact with the space through which the dominant electromagnetic wave propagates within the waveguide 205. The external walls can be separated into external E-plane walls 210 and 211 and external H-plane walls 208 and 209. In certain exemplary embodiments, the external E-plane walls 210 and 211 each have a substantially rectangular shape, are substantially parallel, and located on opposite sides of waveguide 205. Further, the external E-plane walls 210 and 211 are parallel to the E-Plane. Similarly, the external H-plane walls 208 and 209 each have a substantially rectangular shape and are substantially parallel. Further, the external H-plane walls 208 and 209 are parallel to the H-plane and connect the edges of external E-plane walls 210 and 211 to one another.

The waveguide 205 generally defines a rectangular channel 290 throughout its interior to conduct electromagnetic energy. The rectangular channel 290 is defined by interior E-plane walls 224 and 225 and interior H-plane walls 222 and 223. In certain exemplary embodiments, the interior E-plane walls 224 and 225 each have a substantially rectangular shape and are substantially in parallel. Similarly, the interior H-plane walls 222 and 223 each have a substantially rectangular shape and are substantially in parallel. The exemplary channel 290 has a rectangular cross section although other shapes can be used without departing from the scope of the present invention.

The polarization transition waveguide 200 includes a dielectric substrate 260 having a first side 261 and a second side 263 opposite the first side 261. The dielectric substrate 260 can be constructed from any suitable dielectric material, such as a polymer, plastic, Teflon, fiber reinforced Teflon, and the like. The dielectric substrate 260 is disposed in the channel 290 and protrudes out of the waveguide 205 through the opening 226 in the proximate end 206. Although the portion of the dielectric substrate 260 disposed in the channel 290 has a substantially triangular shape, other shapes are feasible.

A ground plane 265 made from an electrically conductive material covers at least a portion of the second side 263 of the dielectric substrate 260. The dielectric substrate 260 is positioned in the channel 290 such that the ground plane 265 faces the interior H-plane wall 223 while the first side 261 faces the interior of the channel 290. Alternatively, the dielectric substrate 260 can be positioned in the channel 290 such that the ground plane 265 faces the interior H-plane wall 222 while the first side 261 faces the interior of the channel 290. In certain exemplary embodiments, the ground plane 265 covers the portion of the second side 263 disposed in the channel 290, while at least a portion of the second side protruding out of the waveguide 205 is not covered by the ground plane 265. This allows for a portion or a strip of ground plane 265 material to be extended from the waveguide 205 to form a dipole leg 253 as discussed in further detail below.

A microstrip (or stripline) transmission line 240 made of an electrically conductive material is formed on the first side 261 of the dielectric substrate 260. The microstrip transmission line 240 is configured in an end-launch configuration whereby the propagation direction of an electromagnetic wave propagating in the waveguide 205 is collinear with the microstrip transmission line 240. That is, the microstrip transmission line 240 runs in a direction from the distal end 207 towards the proximate end 206.

The microstrip transmission line 240 extends through the opening 226 and is turned at a ninety degree angle along the width of the dielectric substrate 260 to form a first dipole leg 251. As briefly discussed above, a portion of the ground plane 265 or a strip of ground plane material or another electrically conductive material extends from the ground plane 265 through the opening 226 along the second side 263 of the dielectric substrate 260. This strip is turned at a ninety degree angle along the width of the dielectric substrate 260 and opposite that of the first dipole leg 251 to form a second dipole leg 253. The two dipole legs 251 and 253 form a dipole radiator 255 that radiates electromagnetic waves having a polarization rotated 90 degrees with respect to the polarization of electromagnetic waves propagating in the waveguide 205 between the distal end 207 and the proximate end 206 as discussed in further detail below. The dipole radiator 255 also receives electromagnetic waves propagating in the open space outside the waveguide 250.

The microstrip transmission line 240 can include a transformer for impedance matching between the microstrip 240 and the dipole radiator 255. In the illustrated embodiment, the microstrip transmission line 240 includes a transformer made up of four microstrip segments 240a-240d having differing widths. In this configuration, the width of the microstrip transmission line 240 decreases in steps from a first segment 240a closest to the rear end 207 to a last segment 240d that forms the first dipole leg 251. That is, the width of segment 240a is greater than the width of segment 240b; the width of segment 240b is greater than the width of segment 240c; and the width of segment 240c is greater than the width of segment 240d. Although in the illustrated embodiment, the microstrip transmission line 240 includes four microstrip segments 240a-240d, this number is exemplary rather than limiting and any number of microstrip segments may be used in alternative exemplary embodiments.

In certain exemplary embodiments, the length of each microstrip segment 240a-240d can be determined based upon the wavelength of electromagnetic waves that will be radiated by the polarization transition waveguide 200. For example, the length of each microstrip segment 240a-240d may be ¼ the wavelength of the electromagnetic waves. This length provides cancellation or suppression of electromagnetic waves reflected by a surface of each of the microstrip segments 240a-240d facing the distal end 207. For example, an electromagnetic wave reflected from a leading edge of the microstrip segment 240a and propagating toward the distal end 207 would have a ¼ wavelength difference than an electromagnetic wave reflected by the leading edge of microstrip segment 240b and propagating toward the distal end 207. At any given position between the leading edge of segment 240a and the distal end 207, the two electromagnetic waves will be approximately 180 degrees out of phase, and essentially cancel.

In certain alternative embodiments, rather than reducing the width as the transmission line 240 extends in the direction of the front end 206, the width of the transmission line 240 may be substantially the same for the entire length of the transmission line 240 or a substantial portion of this length. In certain alternative embodiments, the width of the transmission line 240 may increase as the transmission line 240 extends toward the proximate end 206. This increase in width may be gradual or step-wise. For example, in certain exemplary embodiments, the width of segment 240a may be less than the width of segment 240b; the width of segment 240b may be less than the width of segment 240c; and the width of segment 240c may be less than the width of segment 240d.

The exemplary polarization transition waveguide 200 also includes a waveguide septum 230 that guides the electric field of electromagnetic waves propagating in the waveguide 205 (between the distal end 207 and the proximate end 206) into the microstrip transmission line 240 and provides impedance matching between the waveguide 205 and the microstrip 240. The waveguide septum 230 can be fabricated from a metallic material or another material having a conductive finish on the surfaces exposed in the channel 290.

The waveguide septum 230 is disposed above a portion of the microstrip transmission line 240 and extends from the interior H-plane wall that is opposite the interior H-plane wall contacting the ground plane 265 to the microstrip transmission line 240. The waveguide septum makes contact with the microstrip transmission line section 240a, effectively reducing the height of the channel 290 to the thickness of the microstrip substrate. The waveguide septum 230 can gradually or step-wise reduce the height of the channel 290 above the microstrip transmission line 240 in the direction of propagation for the waveguide 205. That is, the distance between a surface of the interior H-plane wall that contacts ground plane 265 and the nearest surface of the waveguide septum 230 can decrease from the waveguide septum side closest to the distal end 207 to the waveguide septum side closest to the proximate end 206.

The illustrated waveguide septum 230 includes two septum segments 232 and 233 having differing heights (distance from interior H-plane wall 222) that successively guide the electric field of electromagnetic waves into the microstrip transmission line 240. That is, the first septum segment 232 reduces the height of the channel 290 above the microstrip 240 by a first amount and the second septum segment 233 reduces the height of the channel 290 above the microstrip transmission line 240 by a second amount, such that the final reduced height is substantially equal to the substrate thickness of the microstrip transmission line 240. That is, the second septum segment 233 can make contact with the microstrip transmission line 240.

The waveguide septum 230 can be disposed in the channel 290 with a length based upon the wavelength of electromagnetic waves propagating in the waveguide 205. For example, the waveguide septum 230 can be disposed with a length between a first surface 231 of the waveguide septum 230 perpendicular to the H-plane and a second surface 234 of the waveguide septum 230 perpendicular to the H-plane. For example, the length between the first surface 231 and the second surface 234 may be ¼ wavelength so that electromagnetic waves reflecting from the first surface 231 are approximately 90 degrees out of phase with the electromagnetic waves reflecting from the second surface 234. At any position between the first surface 231 and the distal end 207 the two electromagnetic waves will be approximately 180 degrees out of phase, and essentially cancel. This reflective property of the waveguide septum 230 provides impedance matching between the waveguide 205 and the microstrip transmission line 240.

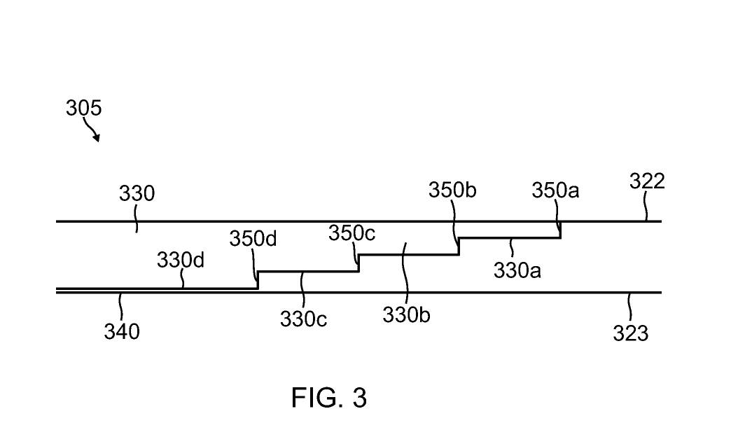

Although the illustrated embodiment includes two septum segments 232 and 233, any number of septum segments can be used in alternative exemplary embodiments. For example, FIG. 3 is a cross-sectional view of a septum 330 disposed in a waveguide 305 having interior H-plane walls 322 and 323, in accordance with certain exemplary embodiments. Referring now to FIG. 3, the exemplary waveguide septum 330 includes four septum segments 330a-330d that guide the electric field of electromagnetic waves into a microstrip transmission line 340. The length of septum segments 330a-330d and the height of septum steps 350a-350d can be sized such that electromagnetic waves reflected from each discontinuity cancel each other, as described above.

In certain alternative embodiments, rather than step changes in height, the waveguide septum 330 can have a height that increases gradually in the direction of propagation of the waveguide 305. The rate of increase can be designed such that reflected electromagnetic waves are minimized, similar to that of the illustrated embodiment.

Referring back to FIG. 2, in certain exemplary embodiments, the waveguide septum 230 can have a width substantially equal to the width of the first microstrip segment 240a, greater than the width of the first microstrip segment 240a, or less than the width of the first microstrip segment 240a. In certain exemplary embodiments, the waveguide septum 230 can be positioned in the waveguide 205 such that the last septum segment 233 (the septum segment closest to the proximate end 206) is disposed substantially over the first microstrip segment 240a (closest to the distal end 207). In certain alternative embodiments, the waveguide septum 230 can be positioned in the waveguide 205 such that the last septum segment 233 extends past the microstrip transmission line 240 towards the distal end 207. In certain alternative embodiments, the waveguide septum 230 can be positioned in the waveguide 205 such that the microstrip transmission line 240 extends past the last septum segment 233 towards the distal end 207. En certain exemplary embodiments, the last septum segment 233 can extend substantially to the opening 226 or through the opening 226.

The exemplary polarization transition waveguide 200 also includes two optional fences 271 and 273 disposed on either side of the opening 225. The fences 271 and 273 can be made of a conductive material or other material operable to block electromagnetic waves propagating in the waveguide 205 from exiting the waveguide 205 through the fences 271 and 273. This prevents cross-polarized radiation from leaving the waveguide 205.

The exemplary polarization transition waveguide 200 includes a waveguide to dipole transition including a waveguide septum 230, a microstrip transmission line 240, and a dipole radiator 255 having a first dipole leg 251 formed from the microstrip transmission line 240 and a second dipole leg 251 formed using a strip of the ground plane 265. The polarization transition waveguide 200 can rotate the polarization of an electromagnetic wave, such as a TE₁₀ rectangular waveguide mode electromagnetic wave, delivered to the opening 221 in the distal end 207 and propagating from the distal end 207 towards the proximate end 206. The electromagnetic wave is guided into the microstrip transmission line 240 by the waveguide septum 230, which also provides impedance matching between the waveguide 205 and the microstrip transmission line 240. Additional impedance matching between the microstrip transmission line 240 and dipole radiator 255 is achieved by a transformer in the microstrip transmission line 240 leading to the dipole radiator 255. This transformer is formed using gradual or step-wise changes in width of the microstrip transmission line 240.

The energy in the microstrip 240 is transmitted to the dipole legs 251 and 253 and the dipole radiator 255 can radiate an electromagnetic wave having a polarization oriented along its long dimension, which is the dimension extending from the end of dipole leg 251 to the end of dipole leg 253. This polarization is rotated 90 degrees with respect to the polarization of electromagnetic waves that may be radiated by the waveguide not having a waveguide to dipole transition as a waveguide typically radiates electromagnetic waves having linear polarization oriented along the short dimension of the waveguide's proximate end 206, which is along the height of the proximate end 206. Thus, the waveguide to dipole transition provides a 90 degree rotation of the polarization of electromagnetic waves propagating in the waveguide 205.

The polarization transition waveguide 200 can also rotate the polarization of an electromagnetic wave received by the dipole radiator 255. The dipole radiator 255 can receive electromagnetic waves, for example having a polarization oriented along the dipole radiator's long dimension (i.e., the dimension extending from the end of dipole leg 251 to the end of dipole leg 253). The dipole radiator 255 propagates the received electromagnetic wave into the microstrip transmission line 240 and the microstrip transmission line 240 propagates the electromagnetic wave into the waveguide 205. The waveguide septum 230 guides the electromagnetic wave out of the microstrip transmission line 240 and into the channel 290. The electromagnetic wave propagates in the channel 290 towards the distal end 207 where the electromagnetic wave is delivered to the opening 221. This electromagnetic wave delivered to the opening 221 has a polarization oriented along the short dimension of the opening 221, which is the dimension between the interior H-plane walls 222 and 223. Thus, the polarization of the electromagnetic wave delivered to the opening 221 is rotated 90 degrees with respect to the polarization of the electromagnetic wave received by the dipole radiator 255.

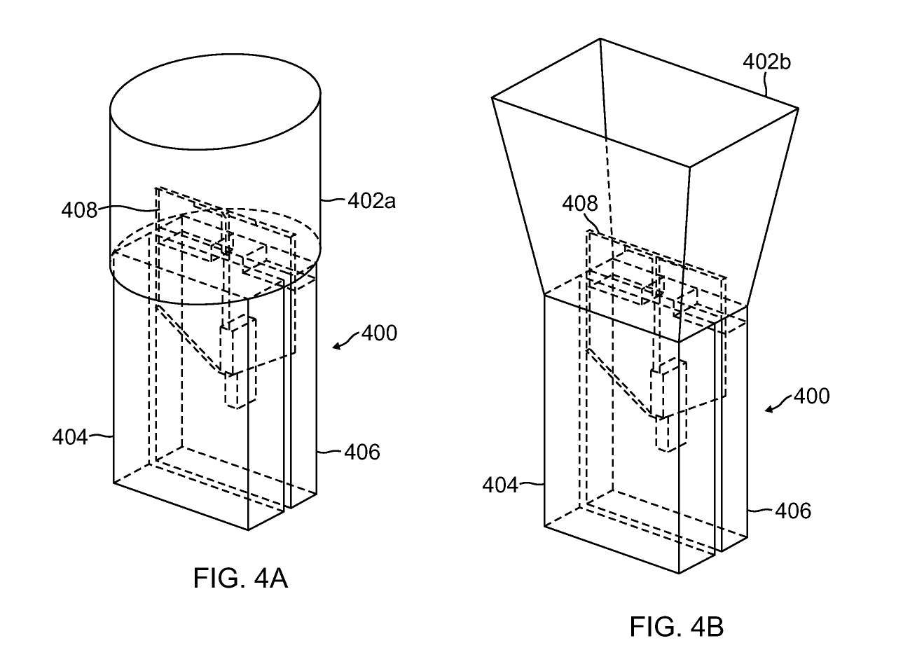

FIGS. 4A and 4B are diagrams illustrating alternative embodiments of waveguide elements 402a and 402b for propagation of a dual polarized signal away from a dual polarization feed 400 as described above in relation to FIG. 1. In FIG. 4A, a circular waveguide element 402a is coupled to dual polarization feed 400 having a first waveguide 404 and a second waveguide 406, where the second waveguide 406 functions as a polarization transition waveguide having a waveguide to dipole transition 408. Signals having orthogonal polarizations are able to propagate within circular waveguide element 402a. In FIG. 4B, a horn waveguide element 402b is coupled to dual polarization feed 400 having a first waveguide 404 and a second waveguide 406, where the second waveguide 406 functions as a polarization transition waveguide having a waveguide to dipole transition 408. Like the rectangular waveguide element 102 of FIG. 1A and the circular waveguide element 402a of FIG. 4A, signals having orthogonal polarizations are able to propagate within horn waveguide element 402b.

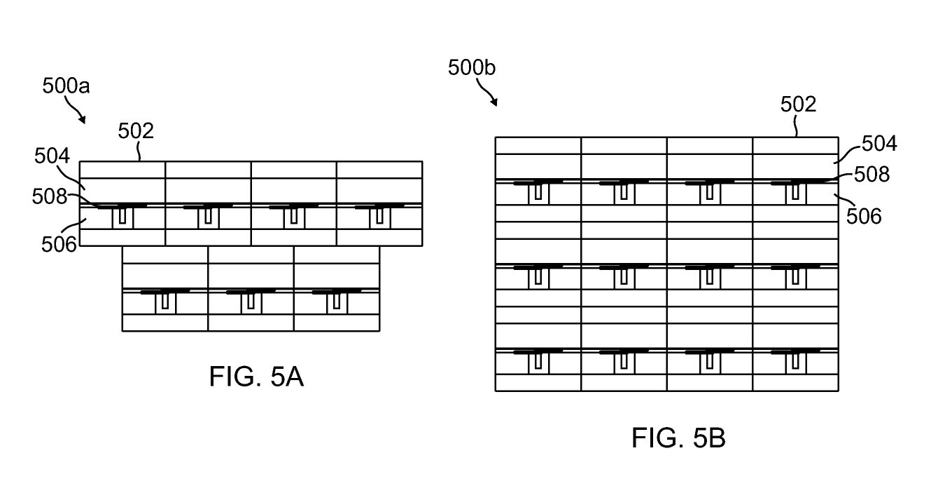

FIGS. 5A and 5B are diagrams of different embodiments of antenna arrays that include dual polarization feeds to provide dually polarized signals to waveguide elements. FIG. 5A is a diagram of an antenna array 500a where different waveguide elements 502 in different rows of waveguide elements 502 are placed next to each other such that edges of the waveguide elements 502 are offset from one another. In contrast to FIG. 5A, FIG. 5B is a diagram of an antenna array 500b where different waveguide elements 502 in different rows of waveguide elements 502 are placed next to each other such that the edges of the waveguide elements 502 are aligned with one another. Further, in at least one embodiment the first waveguide 504, the second waveguide 506, the waveguide to dipole transition 508, and the waveguide element 502 can respectively function as the first waveguide 104, the second waveguide 106, the waveguide to dipole transition 108, and the waveguide element 102. Further each of the waveguide elements 502 in both FIGS. 5A and 5B are fed by a dual polarization feed comprised of a first waveguide 504 and a second waveguide 506, where the second waveguide 506 has a waveguide to dipole transition 508. As described above in relation to FIG. 1, because the waveguide to dipole transition 508 rotates the polarization of signals propagating within the second waveguide 506, both the first waveguide 504 and the second waveguide 506 can be placed next to each other to reduce the size needed by both waveguides to produce a dual polarized signal. Because the first waveguide 504 and the second waveguide 506 have a reduced size, the waveguide elements 502 can also be placed next to each other while having signals of orthogonal polarizations propagating therein.

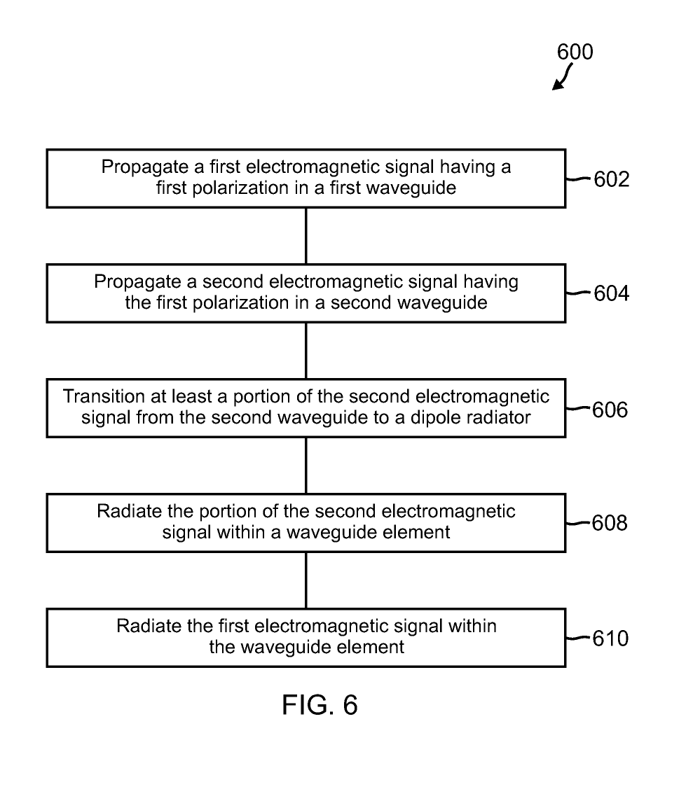

FIG. 6 is a flow diagram of a method 600 for radiating dual polarized and co-located signals within a waveguide element. Method 600 begins at 602, where a first electromagnetic signal having a first polarization is propagated in a first waveguide. Method 600 proceeds to 604, where a second electromagnetic signal having the first polarization is propagated in a second waveguide. In certain exemplary embodiments, both the first and the second waveguide are parallel to one another and propagate signals having the same polarization.

In at least one embodiment, method 600 proceeds to 606, where at least a portion of the second electromagnetic signal is transitioned from the second waveguide to a dipole radiator. In at least one implementation, the portion of the second electromagnetic signal that is transitioned to the dipole radiator is received by an electrical transmission line via a septum. The septum guides the electric field of an electromagnetic signal propagating in the second waveguide into the electrical transmission line and provides impedance matching between the waveguide and the electrical transmission line. Further, the electrical transmission line extends through an opening in the second waveguide on a dielectric substrate and forms a dipole radiator on the end of the dielectric substrate that is not within the second waveguide. Thus the electromagnetic signal is guided into the electrical transmission line, which electrical transmission line transports the propagating signal to the dipole radiator. The transition to the dipole radiator rotates the polarization of the propagating signal by ninety degrees.

In a further embodiment, method 600 proceeds to 608, where the portion of the second electromagnetic signal is radiated within a waveguide element. For example, the dipole radiator radiates the second electromagnetic signal within the waveguide element at a polarization that is orthogonal to the polarization of the second electromagnetic signal propagating within the second waveguide. Method 600 proceeds to 610, where the first electromagnetic signal is radiated within the waveguide element. For example, the first electromagnetic signal propagates through the first waveguide, which is coupled to the waveguide element and first electromagnetic signal is propagated into the waveguide element. Both the first electromagnetic signal and the second electromagnetic signal are propagated into the waveguide element, where the first electromagnetic signal and the second electromagnetic signal are orthogonally polarized in relation to one another. Because the first electromagnetic signal and the second electromagnetic signal are propagating within the same waveguide at orthogonal polarizations, the waveguide element can emit co-located signals having different polarities.

### Example Embodiments

Example 1 includes an apparatus for emitting dual polarized signals, the apparatus comprising: a polarization transition waveguide, comprising a first waveguide transmission line; an electrical transmission line coupled to the first waveguide transmission line, wherein a first electromagnetic signal propagating through the first waveguide transmission line propagates between the first waveguide transmission line and the electrical transmission line; and a dipole radiator coupled to the electrical transmission line, wherein the first electromagnetic signal propagates between the electrical transmission line and the dipole radiator, wherein the dipole radiator radiates the first electromagnetic signal in a polarization that is orthogonal to the polarization of the first electromagnetic signal when the first electromagnetic signal propagates in the first waveguide transmission line; a second waveguide transmission line that propagates a second electromagnetic signal having the same polarization as the first electromagnetic signal propagating in the first waveguide transmission line; and a waveguide element coupled to both the polarization transition waveguide and the second waveguide transmission line, wherein the waveguide element propagates both the first electromagnetic signal emitted from the dipole radiator and the second electromagnetic signal.

Example 2 includes the apparatus of Example 1, wherein the waveguide element is at least one of: a square waveguide; a rectangular waveguide; a circular waveguide; and a waveguide horn.

Example 3 includes the apparatus of any of Examples 1-2, wherein the first waveguide transmission line is parallel to the second waveguide transmission line.

Example 4 includes the apparatus of any of Examples 1-3, wherein the electrical transmission line comprises an impedance transformer.

Example 5 includes the apparatus of Example 4, wherein the impedance transformer comprises a gradual change in the width of the electrical transmission line in a direction parallel with the first waveguide's direction of propagation.

Example 6 includes the apparatus of any of Examples 4-5, wherein the impedance transformer comprises a step-wise change in width of the electrical transmission line in a direction parallel with the first waveguide's direction of propagation.

Example 7 includes the apparatus of any of Examples 1-6, further comprising a waveguide septum disposed in a channel of the waveguide and operable to guide electromagnetic waves propagating in the channel into the electrical transmission line.

Example 8 includes the apparatus of Example 7, wherein the waveguide septum is disposed between a wall of the channel and a portion of the electrical transmission line and comprises a plurality of segments providing a step-wise reduction in open space above the electrical transmission line in a direction parallel to the first waveguide's direction of propagation.

Example 9 includes the apparatus of any of Examples 7-8, wherein the waveguide septum is disposed between a wall of the channel and a portion of the electrical transmission line and comprises a gradual change in height in open space above the electrical transmission line in a direction parallel to the first waveguide's direction of propagation.

Example 10 includes the apparatus of any of Examples 1-9, wherein the first waveguide comprises a channel with an opening in one end and at least one waveguide fence disposed proximal the opening in the one end, the at least one waveguide fence operable to block electromagnetic waves propagating between the channel and free space.

Example 11 includes the apparatus of any of Examples 1-10, wherein the electrical transmission line is formed on a first side of a dielectric substrate and a ground plane covers at least a portion of a second side of the dielectric substrate opposite the first side.

Example 12 includes the apparatus of Example 11, wherein the dipole radiator comprises a first dipole leg formed from an end segment of the electrical transmission line and a second dipole leg formed from an electrically conductive strip extending from the ground plane.

Example 13 includes the apparatus of Example 12, wherein the end segment of the electrical transmission line extends through an opening in the waveguide transmission line and turns 90 degrees to form the first dipole leg.

Example 14 includes the apparatus of Example 13, wherein the strip extending from the ground plane extends through the opening in the transmission line and turns 90 degrees to form the second dipole leg, the turn of the strip extending from the ground plane being in an opposite direction than the turn of the end segment of the electrical transmission line.

Example 15 includes an antenna, the antenna comprising: A first waveguide configured to propagate a first signal having a first polarization; a polarization transition waveguide, wherein the polarization transition waveguide comprises: a second waveguide configured to propagate a second signal having a first polarization; and a waveguide to dipole transition wherein the waveguide to dipole transition rotates the polarization of the second signal to a second polarization, wherein the first polarization is orthogonal to the second polarization; and a radiating waveguide element coupled to both the polarization transition waveguide and the second waveguide, wherein the radiating waveguide element is configured to emit the first signal having the first polarization and the second signal having the second polarization.

Example 16 includes the antenna of Example 15, wherein the waveguide to dipole transition comprises: an electrical transmission line formed on a first side of a dielectric substrate; and a dipole radiator comprising a first dipole leg formed from an end segment of the electrical transmission line and a second dipole leg formed from an electrical conductor electrically coupled to the ground plane of the dielectric substrate, wherein the dipole radiator emits and receives signals that are orthogonally polarized to the polarization of electromagnetic waves propagating within the second waveguide

Example 17 includes the antenna of any of Examples 15-16, further comprising a waveguide septum disposed in the channel and operable to guide at least a portion of electromagnetic energy propagating in the waveguide into the electrical transmission line.

Example 18 includes the antenna of any of Examples 15-17, wherein the antenna is part of an antenna array.

Example 19 includes the antenna of Example 18, wherein the antenna array comprises at least one of: an aligned arrangement of antennas, wherein the edges of the antennas are aligned with one another; and an offset arrangement of the antennas, wherein the edges of the antennas are offset from one another.

Example 20 includes a method for emitting orthogonally polarized, co-located signals, the method comprising: propagating a first electromagnetic signal having a first polarization in a first waveguide; propagating a second electromagnetic signal having the first polarization in a second waveguide; transitioning at least a portion of the second electromagnetic signal from the second waveguide to a dipole radiator; radiating, through the dipole radiator, the portion of the second electromagnetic signal within a waveguide element, wherein the portion of the second electromagnetic signal has a second polarization, wherein the second polarization is orthogonal to the first polarization; and radiating the first electromagnetic signal within the waveguide element

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. An apparatus for emitting dual polarized signals, the apparatus comprising:
a polarization transition waveguide, comprising:
a first waveguide transmission line;
an electrical transmission line coupled to the first waveguide transmission line, wherein a first electromagnetic signal propagating through the first waveguide transmission line propagates between the first waveguide transmission line and the electrical transmission line; and
a dipole radiator coupled to the electrical transmission line, wherein the first electromagnetic signal propagates between the electrical transmission line and the dipole radiator, wherein the dipole radiator radiates the first electromagnetic signal in a polarization that is orthogonal to the polarization of the first electromagnetic signal when the first electromagnetic signal propagates in the first waveguide transmission line;
a second waveguide transmission line that propagates a second electromagnetic signal having the same polarization as the first electromagnetic signal propagating in the first waveguide transmission line; and
a waveguide element coupled to both the polarization transition waveguide and the second waveguide transmission line, wherein the waveguide element propagates both the first electromagnetic signal emitted from the dipole radiator and the second electromagnetic signal.

2. The apparatus of claim 1, wherein the waveguide element is at least one of:
a square waveguide;
a rectangular waveguide;
a circular waveguide; and
a waveguide horn.

3. The apparatus of claim 1, wherein the first waveguide transmission line is parallel to the second waveguide transmission line.

4. The apparatus of claim 1, wherein the electrical transmission line comprises an impedance transformer.

5. The apparatus of claim 4, wherein the impedance transformer comprises a gradual change in the width of the electrical transmission line in a direction parallel with the first waveguide's direction of propagation.

6. The apparatus of claim 4, wherein the impedance transformer comprises a step-wise change in width of the electrical transmission line in a direction parallel with the first waveguide's direction of propagation.

7. The apparatus of claim 1, further comprising a waveguide septum disposed in a channel of the waveguide and operable to guide electromagnetic waves propagating in the channel into the electrical transmission line.

8. The apparatus of claim 7, wherein the waveguide septum is disposed between a wall of the channel and a portion of the electrical transmission line and comprises a plurality of segments providing a step-wise reduction in open space above the electrical transmission line in a direction parallel to the first waveguide's direction of propagation.

9. The apparatus of claim 7, wherein the waveguide septum is disposed between a wall of the channel and a portion of the electrical transmission line and comprises a gradual change in height in open space above the electrical transmission line in a direction parallel to the first waveguide's direction of propagation.

10. The apparatus of claim 1, wherein the first waveguide comprises a channel with an opening in one end and at least one waveguide fence disposed proximal the opening in the one end, the at least one waveguide fence operable to block electromagnetic waves propagating between the channel and free space.

11. The apparatus of claim 1, wherein the electrical transmission line is formed on a first side of a dielectric substrate and a ground plane covers at least a portion of a second side of the dielectric substrate opposite the first side.

12. The apparatus of claim 11, wherein the dipole radiator comprises a first dipole leg formed from an end segment of the electrical transmission line and a second dipole leg formed from an electrically conductive strip extending from the ground plane.

13. The apparatus of claim 12, wherein the end segment of the electrical transmission line extends through an opening in the waveguide transmission line and turns 90 degrees to form the first dipole leg.

14. The apparatus of claim 13, wherein the strip extending from the ground plane extends through the opening in the transmission line and turns 90 degrees to form the second dipole leg, the turn of the strip extending from the ground plane being in an opposite direction than the turn of the end segment of the electrical transmission line.

15. An antenna, the antenna comprising:
A first waveguide configured to propagate a first signal having a first polarization;
a polarization transition waveguide, wherein the polarization transition waveguide comprises:
a second waveguide configured to propagate a second signal having a first polarization; and
a waveguide to dipole transition wherein the waveguide to dipole transition rotates the polarization of the second signal to a second polarization, wherein the first polarization is orthogonal to the second polarization; and
a radiating waveguide element coupled to both the polarization transition waveguide and the second waveguide, wherein the radiating waveguide element is configured to emit the first signal having the first polarization and the second signal having the second polarization.

16. The antenna of claim 15, wherein the waveguide to dipole transition comprises:
an electrical transmission line formed on a first side of a dielectric substrate; and
a dipole radiator comprising a first dipole leg formed from an end segment of the electrical transmission line and a second dipole leg formed from an electrical conductor electrically coupled to the ground plane of the dielectric substrate, wherein the dipole radiator emits and receives signals that are orthogonally polarized to the polarization of electromagnetic waves propagating within the second waveguide

17. The antenna of claim 15, further comprising a waveguide septum disposed in the channel and operable to guide at least a portion of electromagnetic energy propagating in the waveguide into the electrical transmission line.

18. The antenna of claim 15, wherein the antenna is part of an antenna array.

19. The antenna of claim 18, wherein the antenna array comprises at least one of:
an aligned arrangement of antennas, wherein the edges of the antennas are aligned with one another; and
an offset arrangement of the antennas, wherein the edges of the antennas are offset from one another.

20. A method for emitting orthogonally polarized, co-located signals, the method comprising:
propagating a first electromagnetic signal having a first polarization in a first waveguide;
propagating a second electromagnetic signal having the first polarization in a second waveguide;
transitioning at least a portion of the second electromagnetic signal from the second waveguide to a dipole radiator;
radiating, through the dipole radiator, the portion of the second electromagnetic signal within a waveguide element, wherein the portion of the second electromagnetic signal has a second polarization, wherein the second polarization is orthogonal to the first polarization; and
radiating the first electromagnetic signal within the waveguide element.
